(19) United States
(12) Patent Application Publication
(10) Pub. No.: US 2009/0107741 A1
(43) Pub. Date: Apr. 30, 2009

(54) Limited Slip Differential For Electric Vehicle

(75) Inventors: Oliver A. Bell, Aiken, SC (US); Warren Clark, Evans, GA (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/923,937

(22) Filed: Oct. 25, 2007

(51) Int. Cl. B60K 1/00

(52) U.S. Cl. 180/65.6

(57) ABSTRACT

An electric vehicle, such as a golf car or utility vehicle, is provided with an electric motor that provides dynamic braking for the vehicle. The vehicle drivetrain is provided with a limited slip differential in order to prevent the wheels from turning freely when traction is lost.

### FIELD

The present disclosure relates to electric vehicles, and more particularly, to an electric vehicle having dynamic electric motor braking and a limited slip differential for preventing wheel slip during the dynamic braking mode.

### BACKGROUND AND SUMMARY

The statements in this section merely provide background information related to the present disclosure and may not constitute prior art.

Electric vehicles have grown more and more popular for use as golf cars and utility vehicles. Electric vehicles are relatively low maintenance and emit zero environmentally harmful emissions. In addition, electric vehicles are highly reliable.

Although electric vehicles have proven to be very popular and efficient, the need to improve the vehicle's manufacture and assembly still exists. One area of recent development for electrical vehicles relates to the braking system. Examples of such inventions are disclosed in U.S. Pat. Nos. 6,457,568 and 6,686,719 which are commonly assigned. In U.S. Pat. No. 6,457,568, a disc brake system for use with electric vehicles is provided. Electric vehicle disc brake systems are specially designed due to the limited ground clearance of the electric vehicle which has smaller wheels than a standard automotive vehicle. Additionally, U.S. Pat. No. 6,686,719 provides for regenerative braking, wherein electric energy is generated during braking so as to aid in the charging of the vehicle batteries.

The present invention utilizes the drive motor as a source of braking torque. However, braking on slippery surfaces can be difficult when the drive motor is used for providing braking torque. In cases where one wheel loses traction, the other wheel is free to turn, resulting in no braking torque being applied to either of the wheels. This can also happen when an electromechanical brake on the motor shaft is used for emergency braking or for parking. To prevent this problem, the present disclosure provides a limited slip differential mechanism for preventing and/or limiting relative movement between the wheels, thus providing braking torque. In other words, when the first and second output shafts of the differential are prevented from rotating relative to one another, and the input from the motor is braked, the differential is locked up and, therefore, the rear wheels are automatically prevented from rotating.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic view of an electric vehicle drivetrain, including a limited slip differential according to the principles of the present disclosure;

FIG. 2 is a perspective view of an exemplary limited slip differential for use with the present disclosure;

FIG. 3 is an exploded view of the limited slip differential shown in FIG. 2; and

FIG. 4a-4c show various plan views of the limited slip differential.

### DETAILED DESCRIPTION

The following description is merely exemplary in nature and is not intended to limit the present disclosure, application, or uses. It should be understood that throughout the drawings, corresponding reference numerals indicate like or corresponding parts and features.

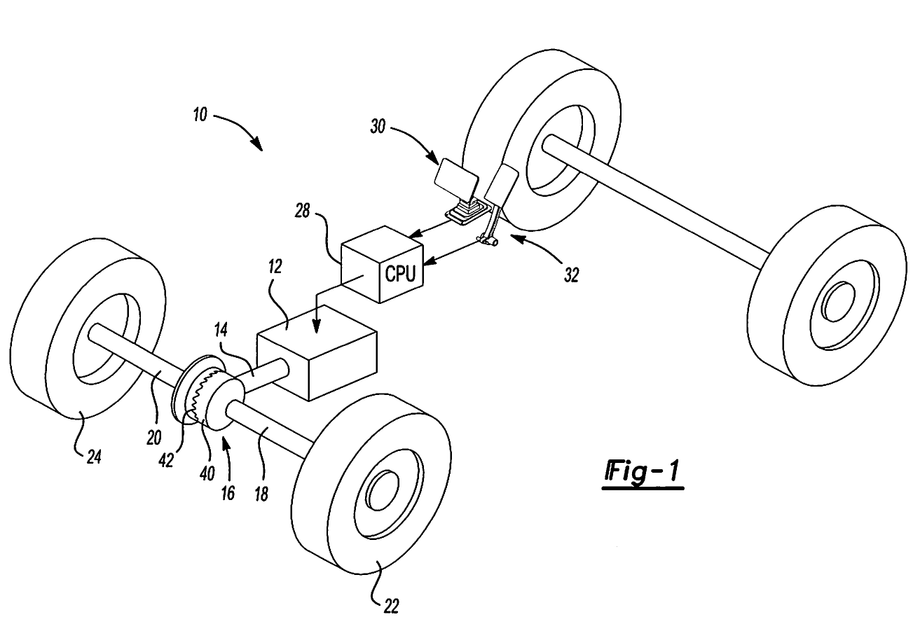

With reference to FIG. 1, an electric vehicle 10, such as a golf car or utility vehicle, is shown including an electric motor 12 including an output shaft 14 connected to a limited slip differential 16. The limited slip differential 16 includes first and second output axle shafts 18, 20 which are connected to the left and right rear drive wheels 22, 24, respectively.

A vehicle central processing unit 28 is provided for controlling operation of the motor 12 for providing driving torque as well as braking torque to the drive shaft 14. The central processing unit 28 receives signals from an accelerator pedal sensor 30 and a brake pedal sensor 32.

The limited slip differential 16 is provided to ensure that one wheel 22, 24 does not spin freely while the other is providing traction. Accordingly, dynamic braking with the electric motor 12 is ensured, even if one of the wheels is provided on a slippery surface. Providing braking by the electric motor 12 accomplishes two things: it returns energy back to the battery by using the electric motor 12 as a generator, and it reduces cost and maintenance associated with a mechanical braking system.

The limited slip differential is installed in an axle carrier 40 which is driven from the intermediate shaft 14 via a ring gear 42 (FIG. 1) which is bolted to the carrier 40. The device operates using a solid pin 44 which is stationary with respect to the carrier 40. Side gears 46 are splined to the clutch plates 48 and alternating clutch plates 50 are splined to the axle shafts 18, 20 when the plates 48 have relative rotation, the side gear 40 slips against the pin 44 compressing the plates 48, 50 and locking the axle shafts 18, 20 and the carrier 40 by the friction between the plates 48, 50. The device also has tabs between the side gears 46 and carrier 40 which allow over-run of the lower torque axle shaft for making turns without turf damage. An exemplary limited slip differential of this type is disclosed in U.S. Pat. No. 6,608,194 which is herein incorporated by reference.

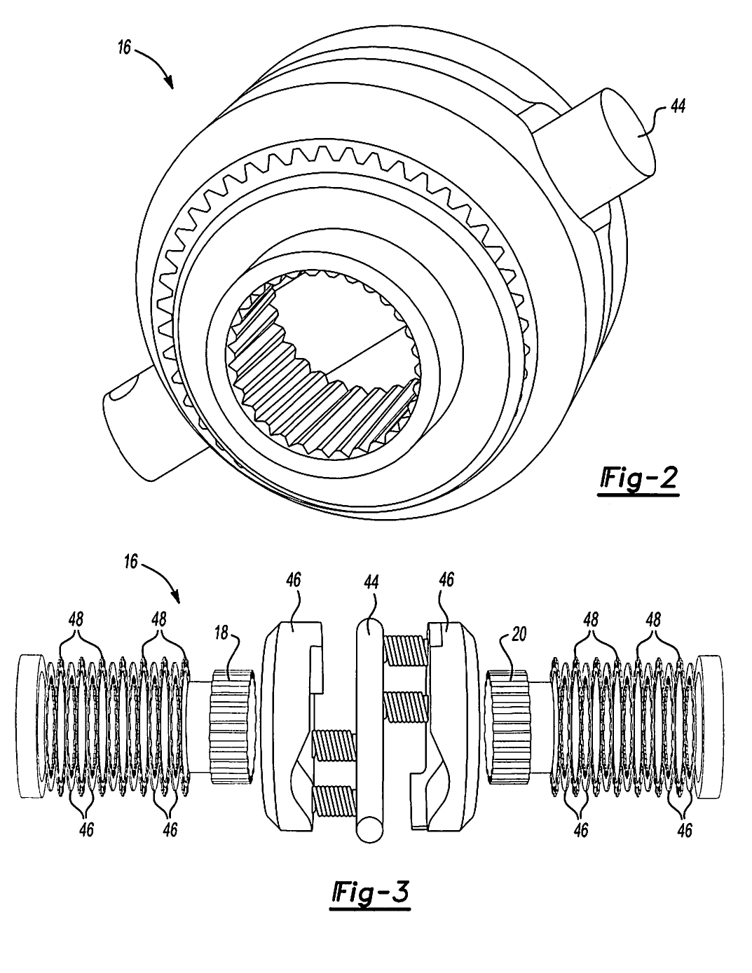

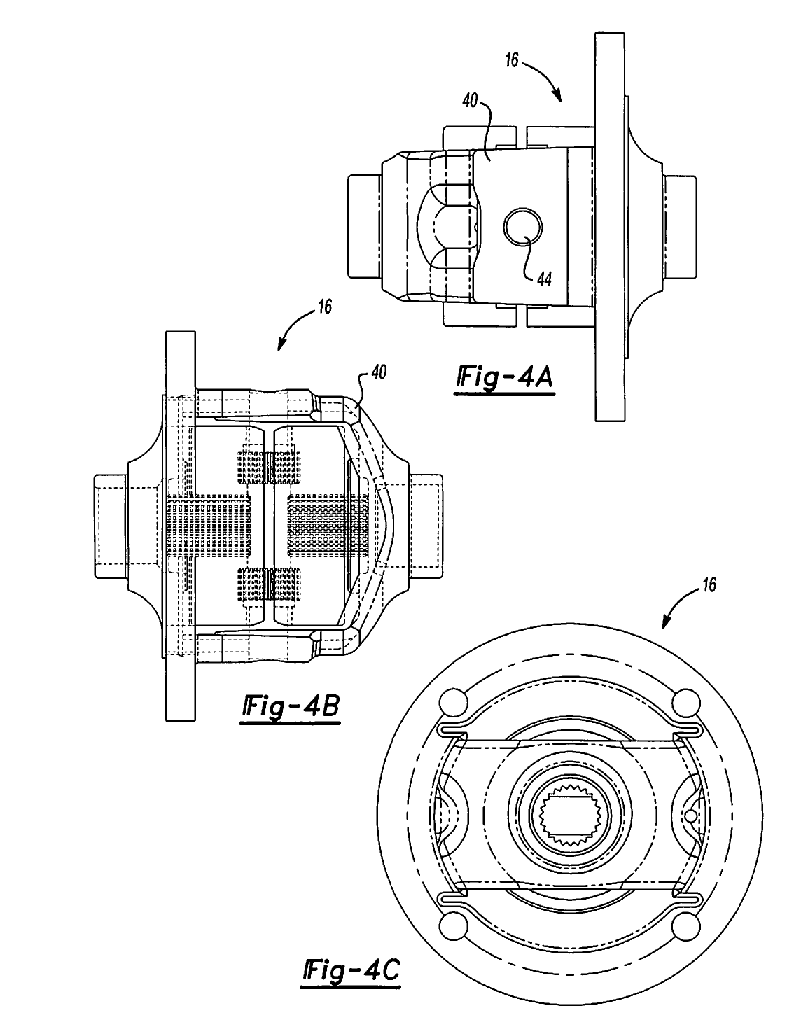

Although an exemplary limited slip differential as shown in FIGS. 2 and 3 is described herein, it should be understood that variety of other limited slip differential designs can be utilized in combination with the electric motor providing dynamic braking in order to achieve the desired results. By way of example, U.S. Pat. Nos. 4,424,725; 6,374,701; 5,836,220; 5,715,733; 5,727,430; 5,413,015; 4,424,725; 4,557,158; 4,644,818 all disclose known limited slip differentials which are hereby incorporated by reference.

What is claimed is:

1. A vehicle comprising:
an electric motor;
a limited slip differential drivingly connected to said electric motor and including first and second output shafts; and
a pair of drive wheels each connected to a respective one of said first and second output shafts.

2. The vehicle according to claim 1, further comprising a controller for controlling said electric motor in response to a brake signal to provide dynamic braking of the electric motor.
